(19) United States
(12) Patent Application Publication
(10) Pub. No.: US 2006/0019615 A1
(43) Pub. Date: Jan. 26, 2006

(54) Wireless keying for a continuous wave (CW) amateur radio transmitter

(76) Inventor: Larry R. Ditmer, Kokomo, IN (US)

Correspondence Address: FRANK D. LACHENMAIER, 116 NORTH MAIN STREET, P. O. BOX 1047, KOKOMO, IN, 46903-1047, US

(21) Appl. No.: 10/897,754

(22) Filed: Jul. 24, 2004

(51) Int. Cl. H04M 3/42

(52) U.S. Cl. 455/90.3

(57) ABSTRACT

This invention generally relates to Morse code sending keys systems. More specifically, this invention relates to a wireless key system that can select a particular amateur radio transmitter on a crowded radio bench and direct it to send Morse code messages in a continuous wave (CW) transmission mode without a physical wired connection between the wireless key and said radio transmitter. The wireless keying system is comprised of a Telegraph Instrument Encoding Unit (TIEU) and a Dit/Dah Decoding Unit (DDU). The TIEU electrically encodes the telegraph contact closures and emits an electro-optical signal, mimicking the closures made by the telegraph key. The DDU detects the emitted electro-optical signal and generates electrical signals for keying on and off the amateur radio transmitter chosen. This wireless keying system supports the transfer of Morse code signals from a telegraph hand key, a paddle key, and those generated by a computer.

### BACKGROUND

1. Field of Invention

This invention generally relates to Morse code sending key systems. More specifically, this invention relates to a wireless key system that can select a particular amateur radio transmitter on a crowded radio bench and direct it to send Morse code messages in a continuous wave (CW) transmission mode without a physical wired connection between the wireless key and radio transmitter.

2. Prior Art

U.S. Pat. No. 5,365,230 to Kikinis discloses a self-contained computer keyboard that communicates keystroke data wirelessly to its host computer via scan codes in a variable magnetic field. This is an inductively coupled system.

U.S. Pat. No. 5,525,981 to Abernathy shows a cordless transducer/cursor having a transmitter for use in conjunction with the receiver of a digitizer tablet. The transmitter receives parallel binary signals representing the status of non-positional functions and the pressure applied to a stylus and converts these signals into a serial stream of binary data for electrostatic or electromagnetic transmission to the receiver which converts this stream of data into a plurality of parallel signals consistent with those sent by the transmitter. U.S. Pat. No. 6,477,357 to Cook discloses the construction of a customizable wireless device such as a wireless phone from a group of stackable modules which can be fastened together in a variety of configurations. U.S. Pat. No. 6,418,323 to Bright shows a cell phone that includes a “dit” button and a “dah” button and sending and receiving circuitry for Morse code communication when non-verbal secrecy is called for in a public place voice communication. The present invention translates the telegraph contact closures or computer Serial Corn Port signals into electro-optical signals for detection by a close distance line of sight optical decoder.

Telegraph operators of commercial, military and amateur radio stations have used telegraph keys connected to electrical wires and cables. Typically the other end of the wire or cable is terminated with a plug which inserts into the transmitter or transceiver's key or paddle jack.

The major users of this technology to transmit Morse code today are the amateur radio operators who have multiple systems on a limited space bench with a jumble of interconnecting wires. It is also a common practice to have a personal computer and keyboard in the area connected to one of the systems as well as microphones, digital communication interfaces, power amplifiers, speakers, audio processing equipment, antennas, ground connections and power connections.

Definitions:
Morse Code—the Continental or International Code that is the universal standard for radio telegraph communications and is the code used by amateur radio operators.
CW—continuous wave is the description used by amateur radio operators that implies operating the transmitter using Morse code.
Contesting—the act of demonstrating proficiency in the use of Morse code by an operator who makes as many contacts with other stations as possible in a given amount of time and within a given set of rules.
Dit—the basic unit of length, same as a dot and same as a short.
Dah—is equal in length to 3 dits, same as a dash or a long.
Keying—general term used to describe the opening and closing of the telegraph key or paddle which results in turning on and off of the transmitter.
Station—the various transmitters and/or receivers along with associated equipment typically in an amateur radio setup.
Keyed—describes the state of a transmitter or transceiver being in the state of CW transmission.
Iambic Keying—the act of sending an alternating sequence of dits and dahs as long as both the dit and dah paddles are depressed or squeezed.
Transceiver—a receiver and transmitter integrated into one unit.
Hand Key—a single lever telegraph key which when depressed makes an electrical contact between its two terminals and is said to be closed or on. When the lever is not depressed, the key is said to be open or off.
Telegraph Paddle—Single Lever—when the lever is not pressed the paddle is said to be open or off. When the paddle is pressed in either direction, electrical contact is made between either the dit or dah contact and the common terminal.
Telegraph Paddle—Dual Lever—when both levers are not pressed the paddle is said to be open or Off. When either lever is pressed electrical contact is made between either the dit or the dah terminal and the common or ground terminal. The two levers make contact to the common terminal independent of each other. Pressing both levers simultaneously signals the system that Iambic Keying is to be performed.
DTR—Data Terminal Ready
RTS—Ready To Send

### SUMMARY

Moving the telegraph sending instrument from one transceiver to another is a difficult and cumbersome task due to the number of wires and cables attached to the back of the transceiver. The transceiver is not easily moved and is hard to see behind in the typical bench or shelf set-up. The workspace in front of the transceiver is also crowded due to the various modes operation used by the amateur radio operator. This space usually contains microphones, telegraph keys and paddles along with other accessories. Since the sending unit is electrically connected to the transceiver and the antenna, the possibility of electrical shock to the operator is great in the event of a power and/or grounding problem. When multiple transceivers are in use, as in a single operator contesting mode where time is of the essence, the use of a dedicated key for each transmitter is the costly and often less than satisfactory solution as each key has its own feel and touch and can slow the operator or generate errors in transmission. The addition of a personal computer for sending Morse code typically requires the use of an external CW interface unit which connects between the computer and transceiver with accompanying cabling adding to the congestion.

The objectives of the Wireless Keying System for a Continuous Wave (CW) Amateur Radio Transmitter are: to provide a Dit/Dah Decoding unit that has selectable output switching to one of a plurality of outputs, moving the connection to subsequent transceivers; to provide a non-physical connection of the sending unit to the transceiver and/or transmitter through the use of an infrared signal in place of wires, making the bench less cluttered and allowing sending unit storage off the bench when not in use; isolating the operator from electrical shock from a grounding or power problem; to provide a system that allows for rapid switching that eliminates the need for multiple sending units and the differences in feel and touch between multiple sending units; to provide an encoding unit that accepts input from all standard telegraph key systems; and to provide an encoding unit that accepts a signal directly from a computer's serial COM port eliminating the need for an external CW interface.

### BRIEF SUMMARY OF INVENTION

The Wireless Keying System for a Continuous Wave (CW) Amateur Radio Transmitter embodies two new units added to a conventional amateur radio station. The first unit is a Telegraph Instrument Encoding Unit or TIEU. When a TIEU is connected to a telegraph sending instrument, shown in phantom lines in the accompanying drawings and not part of this invention, it emits an encoded electro-optical signal representing the action of that telegraph sending instrument lever or levers. The electro-optical signal is made of a series of pulses of three fixed frequencies of F_{dit}, F_{dah}, and F_{iambic} representing the sending of a dit, dah, and the iambic condition respectively. The second unit is the Dit/Dah Decoding Unit or DDU. It receives, amplifies and decodes the electro-optical signal emitted by the TIEU, recreating the electrical Dit and Dah keying signals corresponding to the action made by the telegraph sending instrument lever or levers and routes the keying signals to the selected one of the several transmitters also shown in phantom lines and not part of this invention.

### DRAWINGS

In order that the invention may be more fully understood it will now be described by way of example, with reference to the accompanying drawings in which

FIG. 1 is a block diagram showing TIEU and DDU inputs and outputs

FIG. 2 is a block diagram showing a TIEU interfaced to a Single Lever Telegraph Paddle

FIG. 3 is a block diagram showing a TIEU interfaced to a Dual Lever Telegraph Paddle

FIG. 4 is a block diagram showing a TIEU interfaced to a Telegraph Hand or Straight Key

FIG. 5 is a block diagram showing a TIEU interfaced to a Personal Computer.

FIG. 6 is a block diagram showing a TIEU and DDU configured in a typical application.

FIG. 7 is a block diagram showing a DDU configured with a Wired Telegraph Hand or Straight Key.

FIG. 8 is a block diagram showing a DDU configured with a Wired Dual Lever Telegraph Paddle.

FIG. 9 is a block diagram showing a Telegraph Encoding Unit detailing the oscillators.

FIG. 10 is a block diagram showing a Dit/Dah decoding unit detailing the decoders.

FIG. 11 shows the Morse code lever sequence and the respective electro-optical signal for the Morse Character “A” for the system configured as in FIG. 4.

FIG. 12 shows the Morse code lever sequence and the respective electro-optical signal for the Morse Character “A” for the system as configured in FIG. 2.

FIG. 13 shows the Morse code lever sequence and the respective electro-optical signal for the Morse Character “A” for the system as configured in FIG. 3.

FIG. 14 shows the Serial Corn Port signal sequence and the respective electro-optical signal for the Morse Character “A” for the system as configured in FIG. 5.

FIG. 15 is a block diagram showing a typical Prior Art installation of a personal computer interfaced to a transceiver or transmitter using a CW Interface.

FIG. 16 is a schematic of the Telegraph Instrument Encoding Unit.

FIG. 17 is a schematic of the Dit/Dah Decoding Unit.

### REFERENCE NUMERALS

10—Wireless Keying System for a Continuous Wave (CW) Amateur Radio Transmitter
12—Telegraph Instrument Encoding Unit (TIEU)
14—Dit/Dah Decoding Unit (DDU)
16—Dah input
18—Dit/Dah Reference input
20—Dit input
22—PCS input
24—D4-Electro-optical Emitter/infrared emitting diode
26—D1-Electro-optical sensor/infrared photo diode
28—Keyed output/transmitter selector
30—Keyed output T1
32—Keyed output T2
34—Keyed output T3
36—Keyed output Tₙ
38—Auxiliary key input jack
40—Single Lever Telegraph paddle
42—Dah contact
44—Common contact
46—Dit contact
48—Dual Lever Telegraph Paddle
50—Telegraph Hand or Straight Key
52—Key contact (can be connected to either Dit or Dah input)
54—Personal Computer
56—Serial COM port
58—CW Transmitter 1
60—CW Transmitter 2
62—CW Transmitter 3
64—CW Transmitter n
66—Instrument encoder
68—Oscillators
70—LED output Driver Circuitry
72—Amplifier
74—IC1-Dah Oscillator
76—IC2-Iambic Oscillator
78—IC3-Dit Oscillator
80—IC1-Dah Decoder
82—IC2-Iambic Decoder
84—IC3-Dit Decoder
86—IC4-Dit and Dah Logic
88—F_{dit},
90—F_{dah},
92—F_{iambic}
94—CW interface
96—PCG input
98—Straight or Hand lever
100—Single lever
102—Dit lever
104—Dah lever
106—9 volt Battery
108—9 volt Battery
110—power supply jack
112—S2-Switch
114—Generic mounting backplate/bracket
116—Dit/Dah Decode
118—Dah keying signal
120—Dit keying signal
122—DDU common
124—Dah auxiliary key input
126—Dit auxiliary key input
128—Common auxiliary key input

### DETAILED DESCRIPTION

In order that the invention may be more fully understood, it will now be described by way of example with reference to the accompanying drawings which represent and illustrate several embodiments of Wireless Keying System for a continuous wave (CW) amateur radio transmitter 10. Wireless Keying System 10 can be utilized with input from personal computer 54, Telegraph hand or straight key 50, single lever telegraph paddle 40, or dual lever telegraph paddle 48 and its output is easily switched to one of several transmitters 58 through 64 by turning keyed output/transmitter selector 28 to the desired transmitter number.

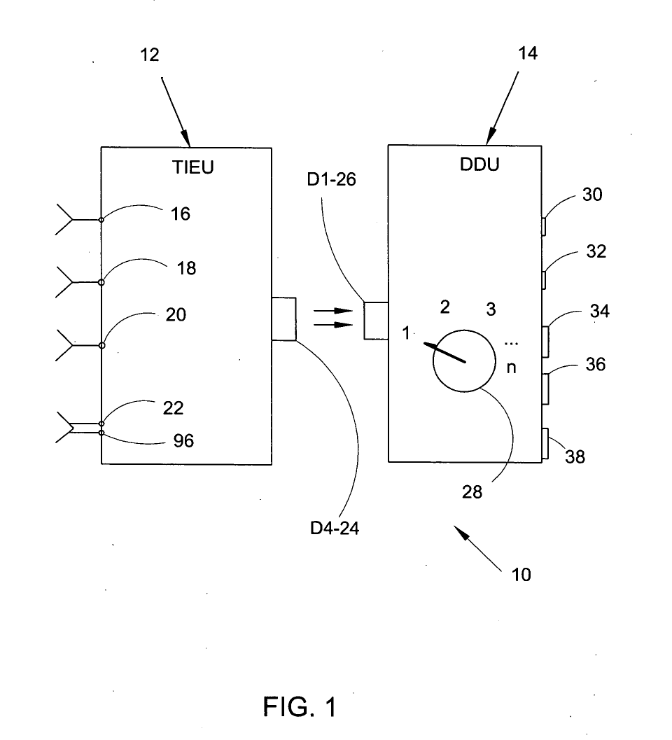

Turning to FIG. 1, the two units that make up Wireless Keying System 10, Telegraph Instrument Encoding Unit (TIEU) 12 and Dit/Dah Decoding Unit (DDU) 14, are represented in block diagrams.

TIEU 12 is shown with the four possible inputs from the various sending units mentioned above. The inputs that can be received are Dah input 16, Dit/Dah reference input 18, Dit input 20 from keys or paddles 40, 48 and 50 and PCS input 22 and PCG input 96 from personal computer 54. The output of TIEU 12 is shown as through D4-electro-optical Emitter/infrared emitting diode 24.

The input into DDU 14 is shown as through D1-electro-optical sensor/infrared photo diode 26. The output of DDU 14 is selected by turning selector 28 to the transmitter that the operator chooses to use. The auxiliary key input jack 38 is also shown in this view and can be utilized for wired telegraph keys if desired. DDU 14 decodes the electro-optical signal emitted by TIEU 12 and recreates the electrical Dit and Dah keying signals corresponding to the action made by the telegraph sending instrument levers and routes the keying signals through outputs 30 through 36 to one of the plurality of transmitters 58 through 64 respectively. DDU 14 is located on an approximate line of sight with TIEU 12 with a preferred separation of approximately 3 meters or less. D1-Electro-optical sensor/infrared photo diode 26 is unaffected by normal levels of room lighting or sun light but some reduced performance of received infrared signal has been observed in the presence of intense direct sunlight or exposure of intense and direct incandescent lighting. Shielding of DDU 14's D1-sensor 26 improves performance in direct sunlight.

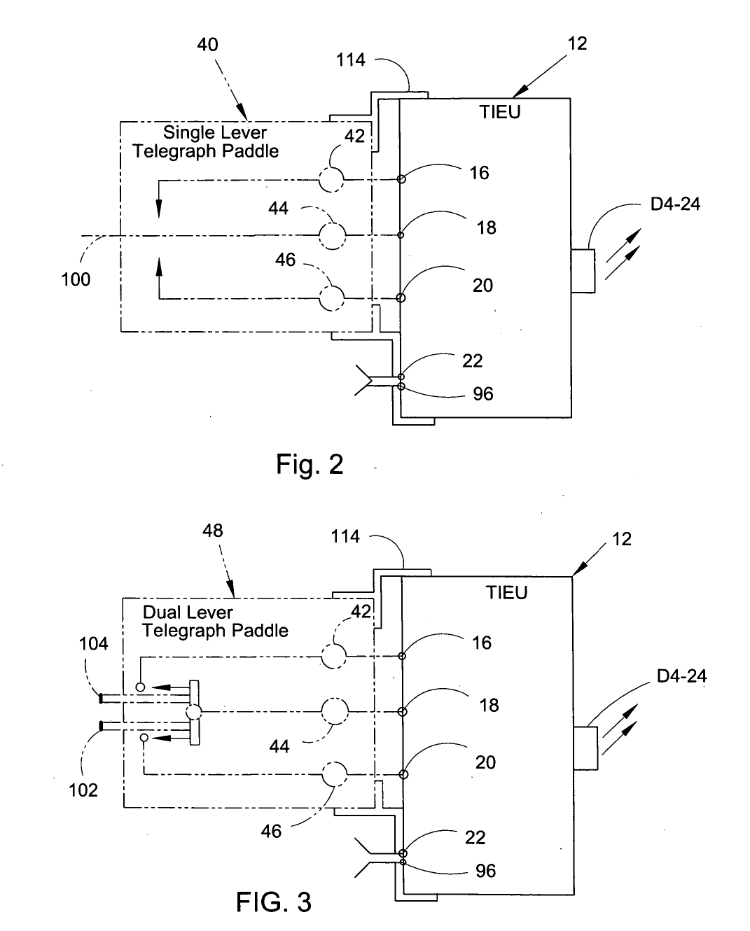

FIGS. 2, 3, and 4, show TIEU 12 mounted to sending Instruments 40, 48, and 50 respectively. These can be mounted using generic mounting backplate/bracket 114 hardware techniques familiar to one skilled in this art, allowing TIEU 12 and the sending instrument to become an integrated unit.

Electrical Connections:

The electrical interconnections between TIEU 12 and Single Lever Telegraph Paddle 40 are shown in FIG. 2. Dah contact 42, on Paddle 40, connects to Dah input 16 on TIEU 12; Common contact 44 connects to Dit/Dah Reference input 18; and Dit contact 46 connects to Dit input 20.

The electrical connections between TIEU 12 and Dual Lever Telegraph Paddle 48 are shown in FIG. 3. Here contacts 42, 44 and 46 connect again to inputs 16, 18 and 20 respectively.

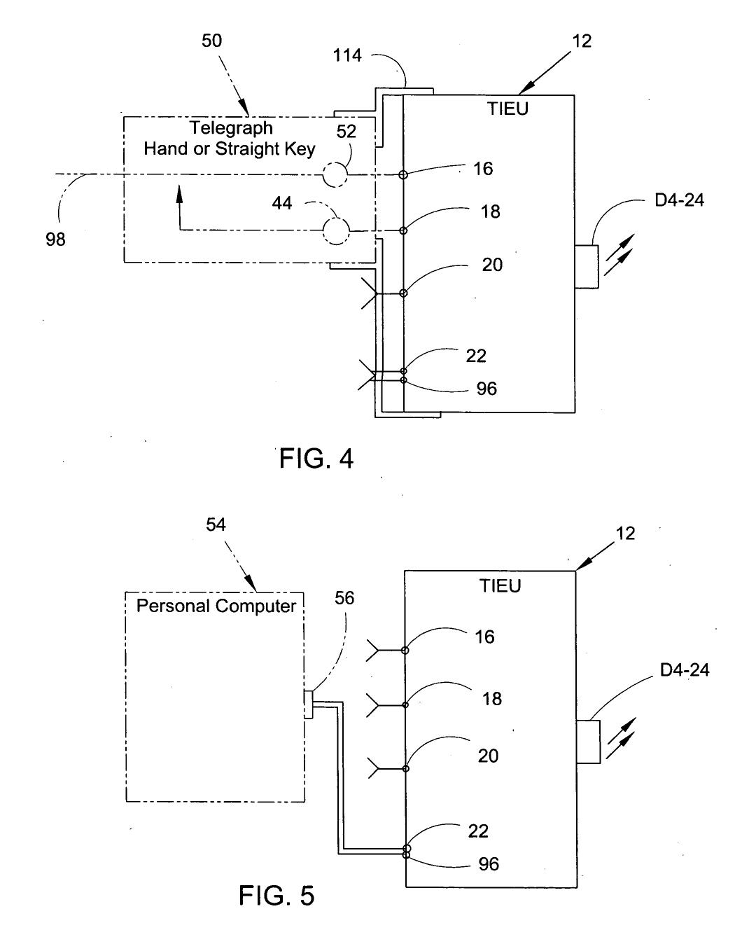

FIG. 4 shows the electrical connections between TIEU 12 and Telegraph Hand or Straight key 50. Here, key contact 52 of hand key 50 connects to either the Dah input 16 or the Dit input 20. The other remains unconnected. Common terminal 44 connects to Dit/Dah Reference input 18.

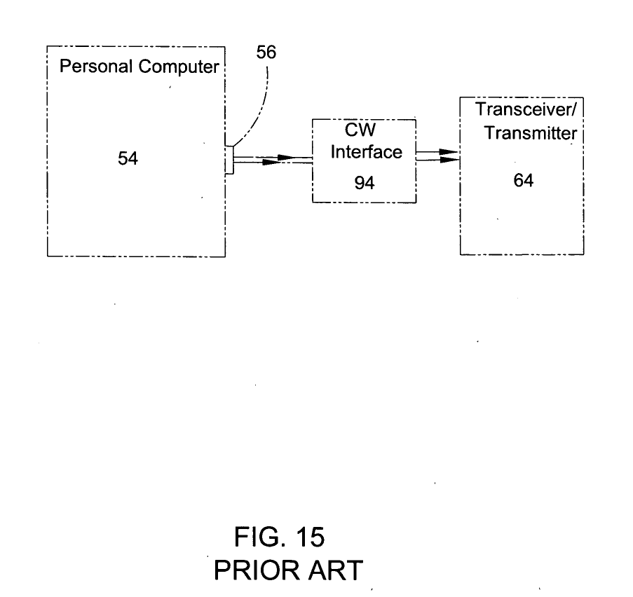

FIG. 5 shows the electrical interface between Personal Computer 54 and TIEU 12. The Serial COM Port 56 signal (e.g. DTR, RTS) on Personal Computer 54 is electrically connected to PCS input 22 on TIEU 12. The Signal Ground for Serial COM Port 56 is connected to PCG input 96 on TIEU 12. FIG. 15 shows a typical prior art wired set-up for personal computer 54 connecting to a transmitter through CW interface 94.

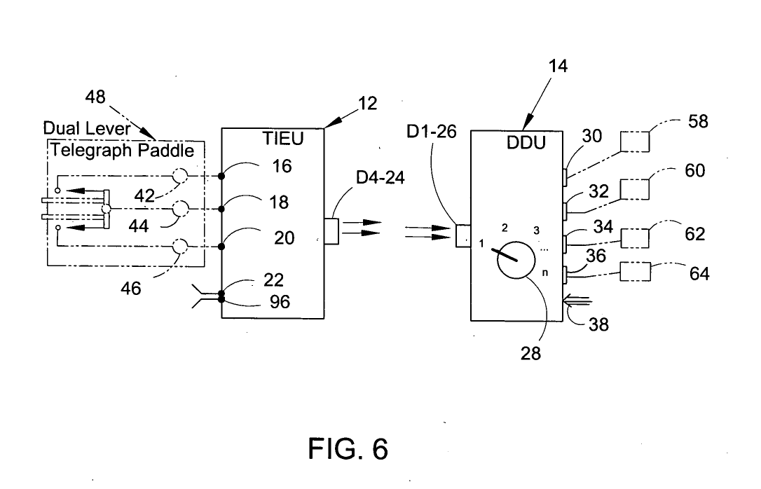

FIG. 6 shows a typical application configuration.

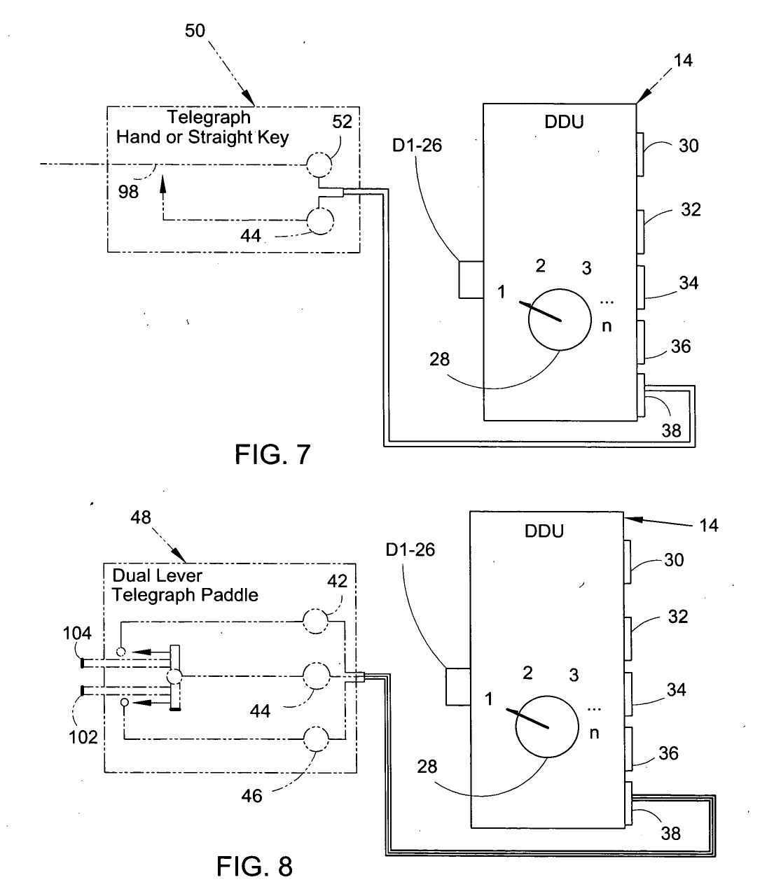

FIGS. 7 and 8 show DDU 14 configurations utilizing auxiliary key input jack 38 for wired key input from sending instruments 50 and 48 respectively with two conductor cable for straight key 50 and three conductor cable for Dual lever paddle 48.

The preceding descriptions are for illustrative purposes and are not intended to limit the scope of this invention. The scope of the invention should be determined by the appended claims rather than by the specific examples given.

Operation:

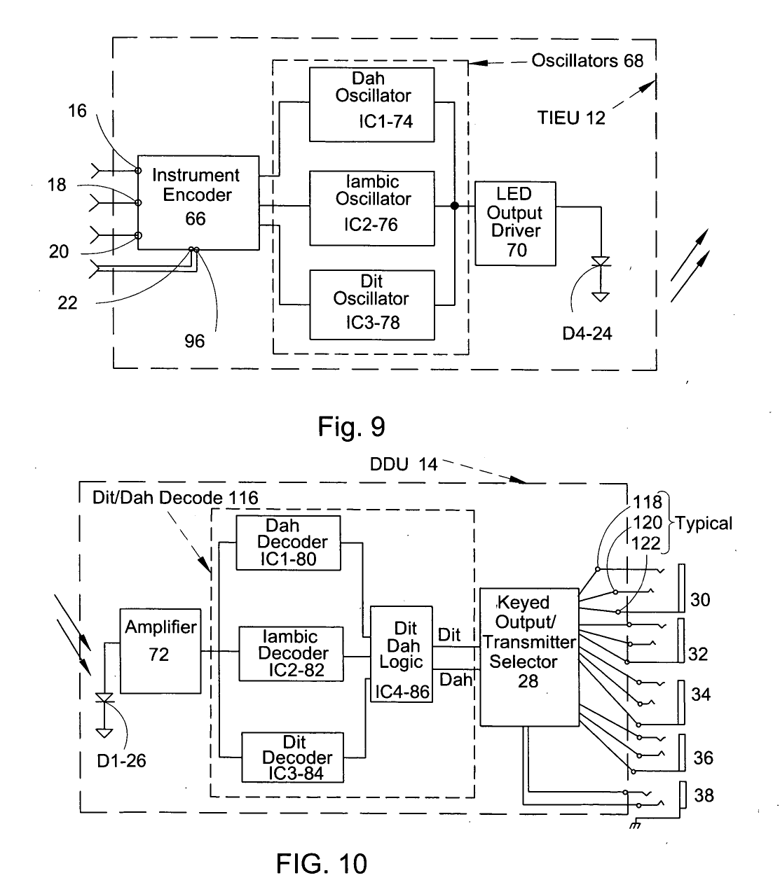

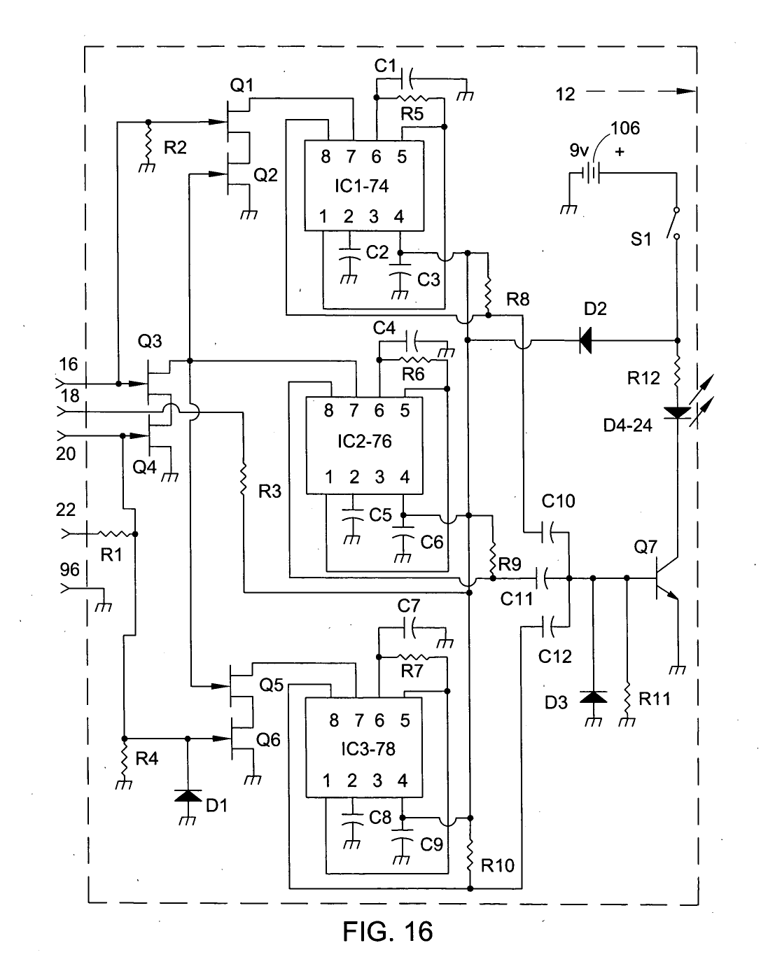

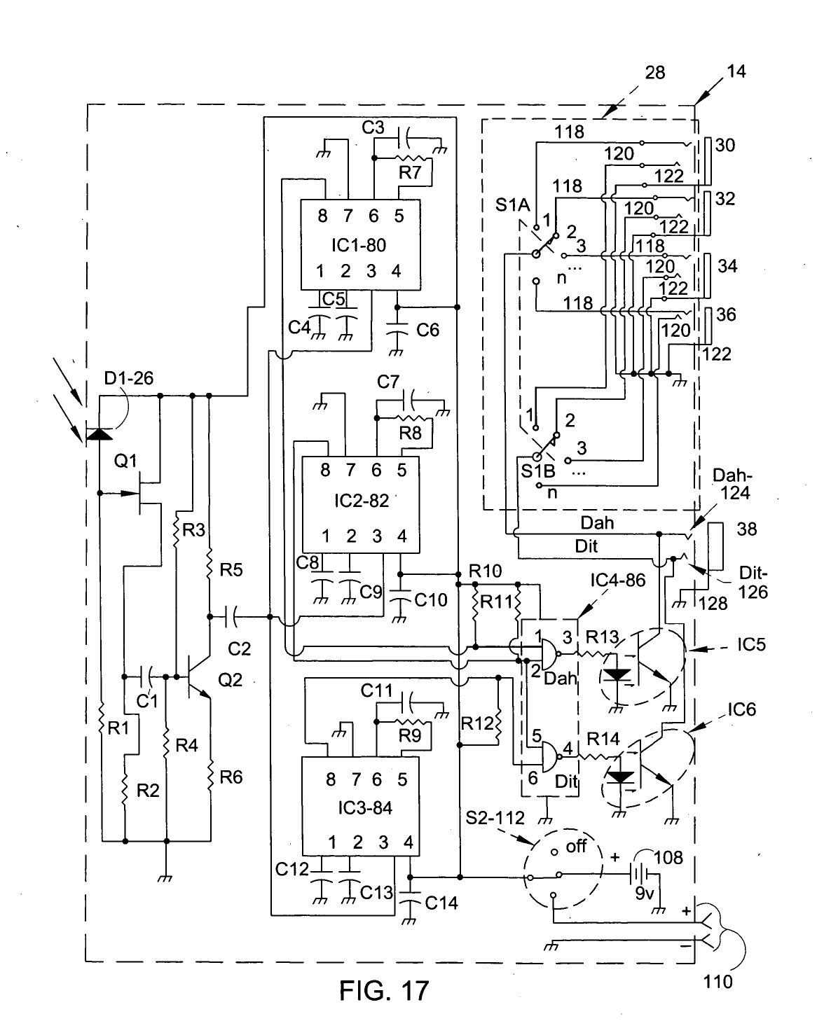

FIGS. 9 and 10 show block diagrams which detail oscillators 68 and Dit/Dah decode 116 sections of TIEU 12 and DDU 14 respectively. FIG. 16 is the schematic for TIEU 12 showing IC1-Oscillator 74, IC2-Oscillator 76 and IC3-Oscillator 78 which are Tone decoder/phase-lock loop IC's. FIG. 17 is the schematic for DDU 14. It details IC1-Decoder 80, IC2-Decoder 82 and IC3-Decoder 84 respectively also as tone decoder/phase-lock loop IC's.

TIEU 12 receives its power from internal 9 volt battery 106 when Switch S1 is closed. When a lever of a telegraph sending instrument is depressed, continuity is established between the lever's corresponding key contact and the common terminal connection of the telegraph instrument.

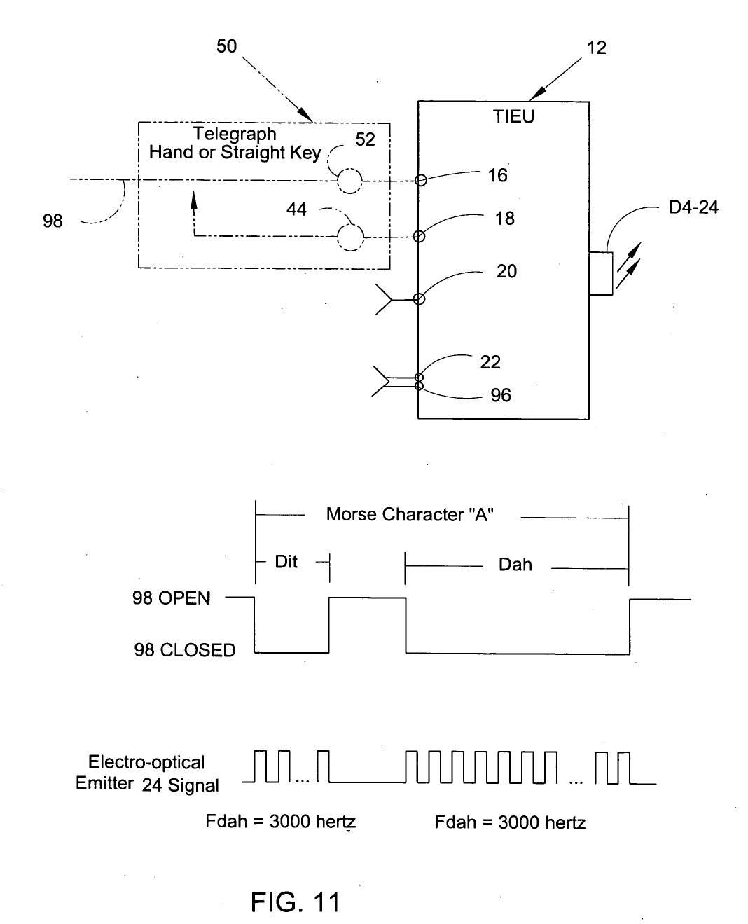

For Straight key 50, depressing lever 98 causes Dah input 16 to be electrically referenced to Dit/Dah reference input 18. As a result, IC1-Dah Oscillator 74 is enabled and oscillates at a predetermined frequency of F_{dah}=3000 hertz, and remains running or oscillating at that frequency as long as lever 98 is depressed as shown in FIG. 11.

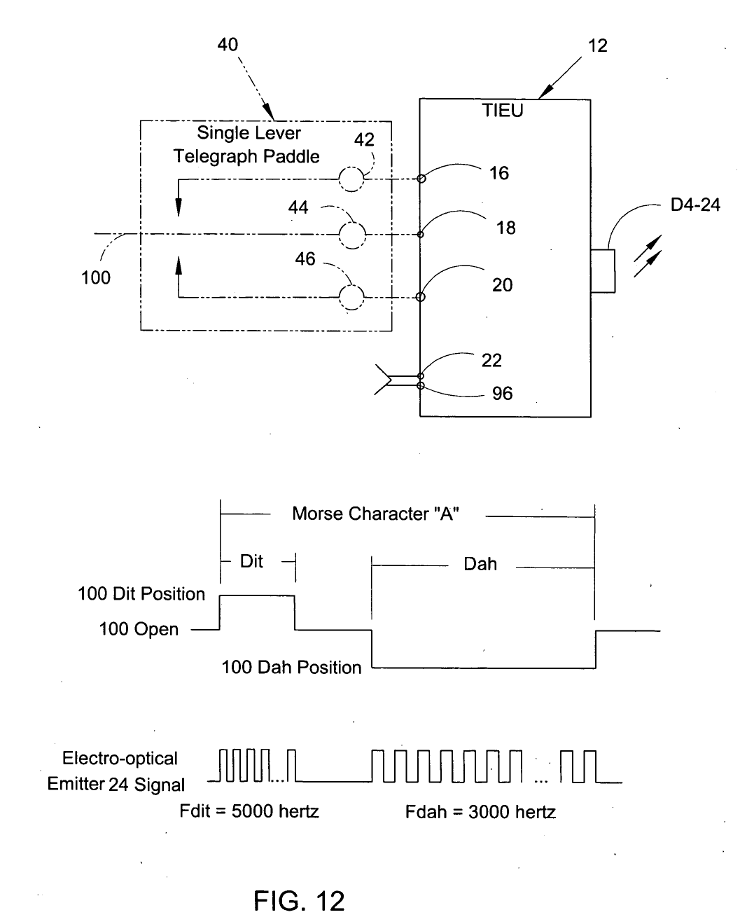

For Single Lever Paddle 40, depressing lever 100 to the Dit position causes Dit input 20 to be electrically referenced to Dit/Dah reference input 18 of TIEU 12. As a result IC3-Dit Oscillator 78 is enabled and oscillates at a predetermined frequency of F_{dit}=5000 hertz and remains running or oscillating at that frequency as long as the lever remains depressed. Depressing lever 100 of telegraph paddle 40 to the Dah position causes Dah input 16 to be electrically referenced to Dit/Dah Reference input 18. As a result IC1-Dah oscillator 74 is enabled and oscillates at a predetermined frequency of F_{dah}=3000 hertz and remains running at that frequency as long as the lever remains depressed as shown in FIG. 12.

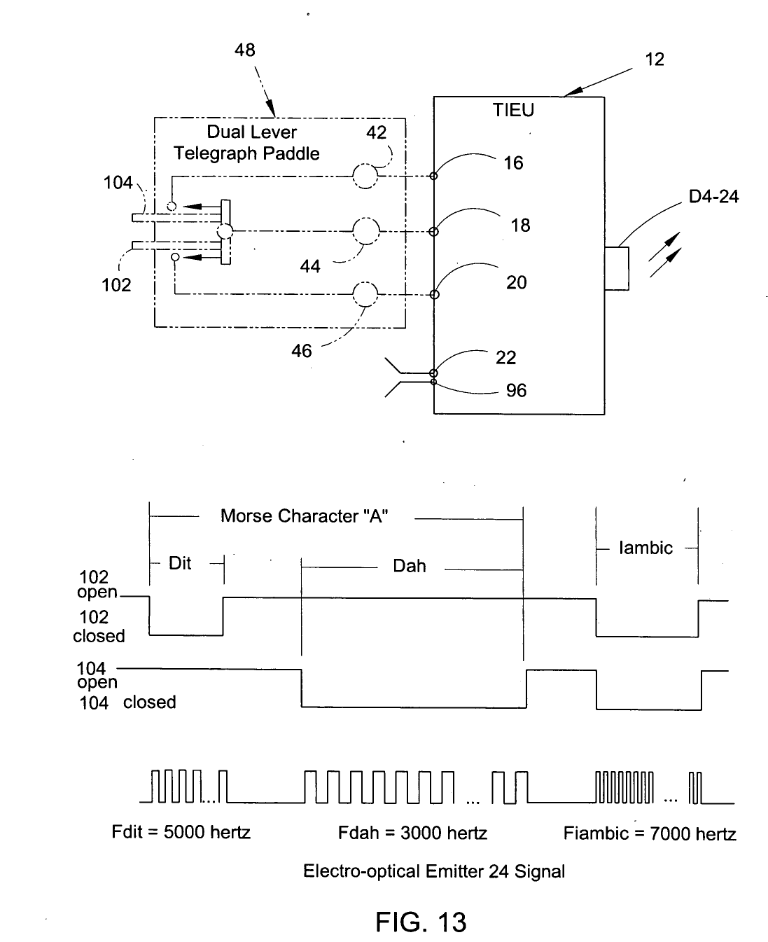

For Dual Lever Telegraph paddle 48, depressing Dit Lever 102 causes Dit Input 20 to be electrically referenced to the Dit/Dah Reference input 18. As a result IC3-Dit Oscillator 78 is enabled and oscillates at a predetermined frequency of F_{dit}=5000 hertz and remains running at that frequency as long as Lever 102 remains depressed. Depressing Dah Lever 104 causes Dah Input 16 to be electrically referenced to the Dit/Dah Reference input 18. As a result IC1-Dah oscillator 74 is enabled and oscillates at a predetermined frequency of F_{dah}=3000 hertz and remains running at that frequency as long as Lever 104 remains depressed. Depressing or squeezing both Dit and Dah Levers 102 and 104 respectively causes both Dit and Dah inputs 20 and 16 respectively to be electrically referenced to Dit/Dah reference input 18. As a result, both IC3-Dit and IC1-Dah Oscillators, 78 and 74 respectively, are disabled and IC2-Iambic Oscillator 76 is enabled and oscillates at a predetermined frequency I_{ambic}=7000 hertz and remains running at that frequency as long as both levers 102 and 104 remain depressed as shown in FIG. 13. As soon as one of the levers is released, IC2-Iambic Oscillator 76 is disabled and the oscillator for the corresponding remaining depressed lever begins to oscillate at its predetermined frequency.

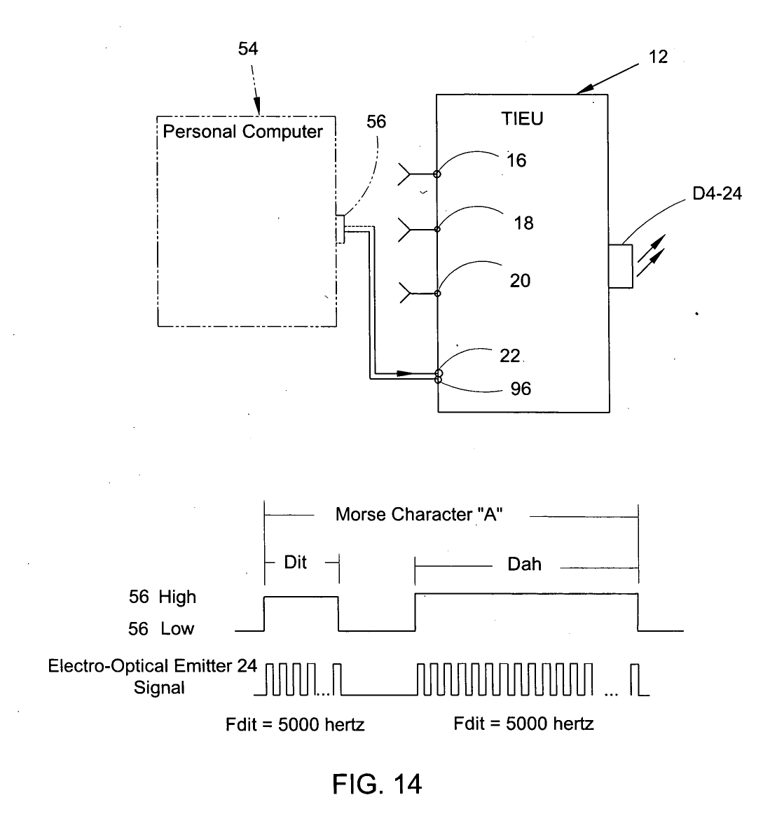

For Morse code signals generated by Personal Computer 54, a code program generates a Serial Corn Port 56 signal (e.g. DTR, RTS) causing PCS input 22 to be electrically referenced above PCG input 96 of TIEU 12. As a result IC3-Dit Oscillator 78 is enabled and oscillates at its predetermined frequency of 5000 hertz and remains running at that frequency as long as so directed by the computer's program as shown in FIG. 14.

An electro-optical signal is generated as the result of one of the three oscillators 68 being applied to LED output Driver Circuitry 70 which causes D4-infrared emitting diode 24 to switch on and off at the frequency of the corresponding oscillator. It is this infrared electro-optical signal which provides the wireless keying information which is detected and decoded by DDU 14.

DDU 14 acquires power from either a 9 volt battery 108 or from external 9 VDC power supply by power supply jack 110 with S2-Switch 112. DDU 14 detects the presence of the emitted electro-optical signal from TIEU 12 by using infrared photo diode 26. The electrical response from D1-photo diode 26 is amplified by Amplifier 72 to a sufficient level for application of frequency detection as shown in FIG. 10. The amplified signal is applied to the IC3-Dit Decoder 84, IC1-Dah Decoder 80 and IC2-Iambic Decoder 82 as shown in FIG. 10. If the applied frequency is within the control range of IC3-Dit Decoder 84, a state change occurs in the decoder's output. This changed state remains as long as the frequency is within the decoder's control range. If the applied frequency is within the control range of IC1-Dah Decoder 80, a state change occurs in the decoder's output. This changed state remains as long as the frequency is within the decoder's control range. Likewise, if the applied frequency is within the control range of IC2-Iambic Decoder 82, a state change occurs in the decoder's output. This changed state remains as long as the frequency is within the decoder's control range. A state change in any of the three decoder's output is interpreted by DDU 14 as a closed lever condition of the telegraph sending instrument. The duration of the state change is controlled by the amount of time that a telegraph sending instrument lever is depressed or squeezed by the operator. The three output signals from the frequency decoders are further decoded to two separate logic signals, i.e., Dah and Dit as shown in FIG. 17 after IC5 and IC6. The Dit and Dah logic signals are buffered providing isolation, utilizing IC5 for the Dah signal and IC6 for the Dit signal and are routed to one of plurality of outputs, 30 through 36, as determined by the position of selector 28. Each output is comprised of Dit keying signal 120, and Dah keying signal 118 and a DDU common 122, as shown in FIGS. 10 and 17.

When straight key 50 is used, Dah signal 118 or Dit keying signal 120 is available at the output when key contact 52 is connected to the Dah input 16 or the Dit input 20 of TIEU 12 respectively. The output connects to the Amateur radio transmitter's paddle jack (not Shown). When paddle 40 or 48 is used both Dit keying signal 120 and Dah keying signal 118 are available at the output and connect to the amateur radio transmitter's paddle jack. Auxiliary Key Input Jack 38 allows the use of a wired telegraph sending instrument, hand key or paddle, and is selectable to one of a plurality of outputs as determined by the position of selector 28. Auxiliary Key Input Jack 38 supports the use of traditional wired keys.

FIGS. 11, 12, 13 and 14 illustrate open and closed lever positions and their corresponding frequency distributions from D4-electro-optical emitter 24 for the Morse code representation of the letter “A” for TIEU 12 interfaced to hand or straight key 50, to Single Lever Paddle 40, to Dual Lever Paddle 48 and to Personal Computer 54 respectively.

Circuitry TIEU:

Turning to FIG. 16, key contacts of the telegraph sending instrument (hand key 50 or paddles 40 and 48) are electrically connected to Dah, Dit and Dah/Dit Reference points 16, 20 and 18 respectively on TIEU 12.

One terminal of hand key 50 is connected to either Dah input 16 or Dit input 20 and the other terminal is connected to Dah/Dit Reference input 18.

For a Single or Dual Lever telegraph paddle 40 or 48, Dah contact 42 is connected to Dah input 16, Dit contact 46 is connected to Dit input 20 and common contact 44 is connected to Dit/Dah Reference 18.

For Morse code generated by a computer, Serial COM Port 56 signals (e.g. DTR or RTS) connect to PCS input 22 on TIEU 12 and Serial COM Port ground connects from PC 54 to PCG input 96 on TIEU 12.

The circuitry of TIEU 12 is powered by a 9 volt battery 106 when switch S1 is closed.

When a telegraph lever is depressed or closed, the corresponding telegraph contact completes the circuit and electrically references the corresponding Dit or Dah input on TIEU 12 to Dit/Dah Reference input 18. The state of the telegraph sending instrument levers and resultant key contact states, i.e., open or closed, are determined by the transistor pairs Q1 and Q2, Q3 and Q4, and Q5 and Q6. These transistor pairs allow only one of IC1-oscillator 74, IC2-oscillator 76 or IC3-oscillator 78 to be enabled at a given time. For Morse code generated by a Personal Computer program, transistor Q6 detects the state of Serial COM Port 56 signal and controls the enabling of IC3-Dit oscillator 78.

When Dah input 16 is referenced to Dit/Dah Reference input 18 as a result of Dah lever 104 of telegraph sending instrument being closed, transistor Q1 turns on completing the ground path for pin 7 of IC1-Dah Oscillator 74. As a result, a fixed oscillation occurs on pin 8 of IC1-Dah oscillator 74. IC1-Dah Oscillator 74 has an oscillation frequency of 3000 hertz as determined by capacitance C1 and resistance R5. When Dah lever 104 of telegraph sending Instrument is opened, transistor Q1 turns off, opening the ground path for pin 7 of IC1-Dah Oscillator 74, causing the fixed oscillation on pin 8 of IC1-Dah Oscillator 74 to stop.

Similarly, When Dit input 20 is referenced to Dit/Dah Reference input 18 as a result of the Dit lever 102 on telegraph sending instrument being closed, transistor Q6 turns on, completing the ground path for pin 7 of IC3 Dit Oscillator 78. As a result, a fixed oscillation occurs on pin 8 of IC3 Dit oscillator 78. IC3-Dit Oscillator 78 has an oscillation frequency of 5000 hertz as determined by capacitance C7 and resistance R7. When the Dit lever 102 of telegraph sending Instrument is opened, transistor Q6 turns off, opening the ground path for pin 7 of IC3 Dit Oscillator 78, causing the fixed oscillation on pin 8 of IC3-Dit Oscillator 78 to stop.

When both Dah input 16 and Dit input 20 are referenced to Dit/Dah Reference input 18 as a result of the both levers on telegraph sending instrument being closed, transistor Q2 and Q5 turn off and transistors Q3 and Q4 turn on. The off states of Q2 and Q5 prevent a ground path for pin 7 of IC1-Dah Oscillator 74 and IC3-Dit Oscillator 78 respectively. The on states of Q3 and Q4 provide the ground path for pin 7 of IC2-Iambic Oscillator 76. As a result, a fixed oscillation occurs on pin 8 of Iambic Oscillator 76—IC2. Iambic Oscillator 76—IC2 has an oscillation frequency of 7000 hertz as determined by capacitance C4 and resistance R6.

When the Dit lever 102 of telegraph sending Instrument is opened while the Dah lever 104 remains closed, transistor Q4 turns off and transistor Q2 turns on. The off state of transistor Q4 opens the ground path for pin 7 of IC2-Iambic Oscillator 76, causing the fixed oscillation on pin 8 of IC2-Iambic oscillator 76 to stop. The on state of transistor Q2 completes the ground path for pin 7 of IC1-Dah Oscillator 74 causing fixed oscillations to occur on pin 8 of IC1-Dah Oscillator 74.

Similarly, when the Dah lever 104 of telegraph sending Instrument is opened while the Dit lever 102 remains closed, transistor Q3 turns off and transistor Q5 turns on. The off state of transistor Q3 opens the ground path for pin 7 of IC2-Iambic Oscillator 76, causing the fixed oscillation on pin 8 of IC2-Iambic Oscillator 76 to stop. The on state of transistor Q5 completes the ground path for pin 7 of IC3-Dit Oscillator 78 causing fixed oscillations to occur on pin 8 of IC3-Dit Oscillator 78. When both levers 102 and 104 of the telegraph sending instrument are opened together, transistors Q3 and Q4 turn off, causing the fixed oscillation on pin 8 of IC2-Iambic Oscillator 76 to stop.

When PCS input 22 is at a high level, as instructed by a Morse code program running on Personal Computer 54, with respect to the PCG input 96, transistor Q6 turns on, completing the ground path for pin 7 of IC3-Dit Oscillator 78. As a result, a fixed oscillation of 5000 hertz occurs on pin 8 of IC3-Dit Oscillator 78. This oscillation is determined by capacitance C7 and resistance R7. When the PCS input 22 returns to the low level, as instructed by the Morse code program running on Personal Computer 54, with respect to PCG input 96, transistor Q6 turns off, opening the ground path for pin 7 of IC3-Dit Oscillator 78, causing the fixed oscillations on pin 8 of IC3-Dit Oscillator 78 to stop.

When IC1-Dah Oscillator 74 is enabled, capacitance C10 provides ac-coupling of IC1-Dah Oscillator's 74 output to the base of Transistor Q7, providing sufficient switching base current to cause the collector of transistor Q7 to switch on and off. The on collector current of transistor Q7 is of a sufficient level as determined by resistance R12 to cause the D4-infrared emitting diode 24 attached to the collector of transistor Q7 to emit a 3000 hertz infrared electro-optical signal.

Similarly, when IC3-Dit Oscillator 78 is enabled, capacitance C12 provides ac-coupling of IC3-Dit Oscillator 78's output to the base of Transistor Q7, providing sufficient switching base current to cause the collector of transistor Q7 to switch on and off. The on collector current of transistor Q7 is of a sufficient level as determined by resistance R12 to cause D4-infrared emitting diode 24 attached to the collector of transistor Q7 to emit a 5000 hertz infrared electro-optical signal.

Likewise, when IC2-Iambic Oscillator 76 is enabled, capacitance C11 provides ac-coupling of IC2-Iambic Oscillator 76's output to the base of transistor Q7, providing sufficient switching base current to cause the collector of transistor Q7 to switch on and off. The on collector current of transistor Q7 is of a sufficient level as determined by resistance R12 to cause D4-infrared emitting diode 24 attached to the collector of transistor Q7 to emit a 7000 hertz infrared electro-optical signal.

The emission of the 3000 hertz infrared signal from TIEU 12 represents the closure of the telegraph sending instrument's Dah lever 104. The emission of the 5000 hertz infrared signal from TIEU 12 represents closure of the telegraph sending instrument's Dit lever 102. The emission of the 5000 hertz infrared signal from TIEU 12 can also represent a High level state from a personal computer's 54 Serial COM Port 56. The emission of the 7000 hertz infrared signal from TIEU 12 represents the closure of the telegraph sending instrument's Dit and Dah levers 102 and 104.

Circuitry DDU:

Turning to FIG. 17, note the circuit diagram for Dit/Dah Decoding Unit, DDU 14, which is powered by either internal 9 volt battery 108 or an external 9 VDC supply via power supply jack 110 and is selectable by S2-switch 112.

When DDU 14 is powered, the optical power from D1-infrared photodiode 26 is converted and amplified into a sufficient electrical signal by transistors Q1 and Q2. IC1-Dah Decoder 80, IC2-Iambic Decoder 82 and IC3-Dit Decoder 84 perform frequency detection and comprise Dit/Dah Decode 116 circuitry of DDU 14. See FIG. 10 for details on Dit/Dah Decode 116. The signal from the collector of transistor Q2 is applied to the pin 3 inputs of IC1-Dah Decoder 80, IC2-Iambic Decoder 82 and IC3-Dit Decoder 84 by capacitance C2. When the emitted infrared signal from TIEU 12 is within a distance of approximately 3 meters or less of DDU 14's D1-infrared photodiode 26, a sufficient signal is present for detection by the frequency decoders. The IC1-Dah Decoder 80, IC2-Iambic Decoder 82 and IC3-Dit Decoder 84 are designed to lock on frequencies centered about 3000, 7000 and 5000 hertz respectively. These are the three frequencies emitted by TIEU 12.

IC1-Dah Decoder 80's center frequency is determined by capacitance C3 and resistance R7. Its control range is determined primarily by capacitances C4 and C5.

IC3-Dit Decoder 84's center frequency is determined by capacitance C11 and resistance R9. Its control range is determined primarily by capacitances C 12 and C13.

IC2-Iambic Decoder 82's center frequency is determined by capacitance C7 and resistance R8. Its control range is determined primarily by capacitances C8 and C9.

A state change from high to low occurs on the decoder's output pin 8 when the applied signal to input pin 3 of the decoder is within the control range of the frequency decoder. The low state remains as long as the frequency stays within the control range of the decoder. A low state in any of the three decoder's output is interpreted by DDU 14 as a closed lever condition of the telegraph sending instrument. The emission of the 3000 hertz signal from TIEU 12 will cause IC1-Dah Decoder 80 output to stay low the amount of time that the telegraph sending instrument's Dah lever 104 is depressed or squeezed. The emission of the 5000 hertz signal from TIEU 12 will cause IC3-Dit Decoder 84 output to stay low the amount of time that the telegraph sending instrument's Dit lever 102 is depressed or squeezed. The emission of the 7000 hertz signal from TIEU 12 will cause IC2-Iambic Decoder 82 output to stay low the amount of time that the telegraph sending instrument's Dit and Dah levers 102 and 104 are both depressed or squeezed.

IC4-Dit and Dah Logic 86 performs decoding of the three frequency decoder's outputs. A low state on output pin 8 of either IC1-Dah Decoder 80 or IC2-Iambic Decoder 82 signifies a Dah condition and a low state on output pin 8 of either IC3-Dit Decoder 84 or IC2-Iambic Decoder 82 signifies a Dit condition causing a high state on pin 3 and pin 4 of IC4-Dit and Dah Logic 86 respectively. The high state of pin 3 of IC4-Dit and Dah Logic 86 supplies sufficient current through photodiode of IC5, causing the transistor of IC5 to go low when the collector of transistor of IC5 is connected to key or paddle jack of an amateur radio transmitter or transceiver by way of Keyed output/transmitter selector 28. The low condition of the transistor of IC5 causes the Dah input of the amateur radio transmitter or transceiver to be keyed. Similarly, the high state of pin 4 of IC4-Dit and Dah Logic 86 supplies sufficient current through the photodiode of IC6, causing the transistor of IC6 to go low when the collector of transistor IC6 is connected to key or paddle jack of an amateur radio transmitter or transceiver by way of Keyed output/transmitter selector 28. The low condition of the transistor of IC6 causes the Dit input of the amateur radio transmitter to be keyed.

Keyed output/transmitter selector 28 contains ganged switches S1A and S1B which provide selection of one of a plurality of keying outputs of DDU 14. Each keyed output 30 through 36 of DDU 14 is comprised of Dit keying signal 120, Dah keying signal 118 and DDU common 122. Keyed outputs 30 through 36 provide the electrical keying connections between DDU 14 and CW Transmitters 58 through 64.

DDU 14 also provides auxiliary input jack 38 for use with conventionally wired telegraph sending instruments. Keyed output/transmitter selector 28 ganged switches S1A and SIB provide connection of the wired telegraph sending instrument to one of the plurality of keying outputs 30 though 36.

The invention claimed is:

1. A wireless keying system for operating one of a plurality of amateur radio transmitters in continuous wave transmission mode comprising:
a telegraph instrument encoding unit that receives and electrically encodes telegraph key contact closures of a telegraph sending instrument and emits an electro-optical signal that mimics said key contact closures; and
a Dit/Dah decoding unit which detects said emitted electro-optical signal from said telegraph instrument encoding unit and decodes it into electrical signals for keying a continuous wave radio transmitter on and off that mimic said key contact closures,
whereby the use of wires or cables connecting said sending instruments to said transmitters and the commensurate clutter is eliminated and the operator is electrically isolated from said transmitter and associated antenna system.

2. A wireless keying system for operating an amateur radio transmitter in continuous wave transmission mode as in claim 1 wherein
inputs received by said telegraph instrument encoding unit from a telegraph hand or straight key sending instrument take the form of Dit, Dah or Dit/Dah Reference; and
where the Dit or Dah keying signal from one of the plurality of outputs of said decoding unit is used to key said transmitter.

3. A wireless keying system for operating an amateur radio transmitter in continuous wave transmission mode as in claim 1 wherein
inputs received by said telegraph instrument encoding unit from a single lever or a dual lever telegraph paddle sending instrument are Dit, Dah or Dit/Dah Reference; and
where said Dit and Dah keying signals from one of a plurality of said outputs of said decoding unit are used for keying said selected transmitter.

4. A wireless keying system for operating an amateur radio transmitter in continuous wave transmission mode as in claim 1 wherein
inputs received by said telegraph instrument encoding unit from a serial Corn port of a personal computer are entered as a PCS and PCG signal and said Dit keying signals from one of a plurality of said outputs of said decoding unit are used for keying said transmitter.

5. A wireless keying system for operating an amateur radio transmitter in continuous wave transmission mode as in claim 1 wherein
said electro-optical signal that mimics said contact closures, employs an infrared emitting diode as the electro-optical emitting device emitting three different frequencies, representing a Dit by oscillating at 5000 hertz when its Dit input is electrically referenced to its Dit/Dah Reference, a Dah by oscillating at 3000 hertz when its Dah input is electrically referenced to its Dit/Dah Reference and the Iambic condition by oscillating at 7000 hertz when both its Dit and Dah inputs are electrically referenced to its Dit/Dah Reference;
said Dit/Dah decoding unit which detects said emitted electro-optical signals from said telegraph instrument encoding unit employs an infrared photodiode as the sensing device;
said infrared emitting diode and said infrared photodiode are arranged in a line of sight approximately 3 meters apart or less; and
said telegraph instrument encoding unit runs on an internal 9 volt battery and said decoding unit runs on either a 9 volt battery or a 9 VDC power supply.

6. A wireless keying system for operating an amateur radio transmitter in continuous wave transmission mode as in claim 1 wherein
said telegraph instrument encoding unit is configured as to be electrically connectable to terminals of said commercially available telegraph hand or straight key, single lever and dual lever paddle sending instruments and mountable onto said instruments using Generic mounting backplates/brackets.

7. A wireless keying system for operating an amateur radio transmitter in continuous wave transmission mode as in claim 1 wherein
said Dit/Dah decoding unit is configured:
to be electrically connectable to the hand key input jack and to the paddle jack of said commercially available amateur radio transmitter;
to provide a plurality of said keyed outputs for connection to said multiple amateur radio transmitters;
to provide a keyed output/transmitter selector whereby rapid change from one transmitter to another is possible, eliminating need for separate sending instruments for each transmitter; and
to provide an auxiliary key input for use with conventionally wired sending instruments which can be also switched to any of said plurality of keyed outputs.

8. A wireless keying system for operating an amateur radio transmitter in continuous wave transmission mode as in claim 1 wherein
said telegraph instrument encoding unit accepts a signal directly from said personal computer's Serial Com Port, thereby eliminating a need for an external CW Interface, allowing wireless transfer of Morse code information from said personal computer by means of said infrared signal from said telegraph instrument encoder unit to said Dit/Dah decoder unit.

9. A method of sending Morse code signals wirelessly from one of several telegraph sending instruments to one of a plurality of continuous wave amateur radio transmitters comprised of the following steps:
connecting said telegraph sending instrument selected from a group consisting of telegraph hand or straight key, single lever paddle, dual level paddle and personal computer to a telegraph instrument encoding unit;
generating electrical signals from said telegraph sending instruments based upon the opening and closing of contacts on said instruments representing Dit, Dah, and Iambic condition states of said instruments;
receiving said electrical signals in said encoding unit;
distributing said electrical signals to Dit, Dah and Iambic oscillators in said encoding unit which oscillate at 5000, 3000 and 7000 hertz respectively when enabled;
enabling one of said oscillator based on said electrical signal;
applying oscillation signal to an infrared emitting diode which emits a pulsed infrared signal at the frequency of said enabled oscillator;
aligning, along a line of sight and within approximately 3 meters or less, said infrared emitting diode on said telegraph instrument encoding unit with an infrared photodiode on a Dit/Dah decoding unit;
receiving said pulsed infrared signal by said infrared photodiode on said decoding unit;
amplifying said pulsed infrared signal to a level sufficient to be detectable by one of the three decoders;
directing amplified pulsed signal to Dit, Dah and Iambic decoders which are switched to a low state when exposed to a signal within their individual control ranges and return to a high state when said signal falls outside the given decoder's control range which are centered on 5000, 3000 and 7000 hertz, matching the output ranges of said telegraph instrument encoder unit representing said Dit, Dah and Iambic conditions of said sending instruments;
decoding further, said high and low states of said three decoders are sent to a logic section where said decoder states are broken into either Dit or Dah keying signals and buffered;
transferring either of said Dit and Dah keying signals from said logic section or from said sending instruments that have been hard wired into the auxiliary input jack to Keyed output/transmitter selector;
selecting a transmitter for use by turning said selector to appropriate transmitter number where a plurality of transmitters are connected to said Dit/Dah decoding unit; and
sending Morse code message on said telegraph sending instrument which causes the desired interruptions in the continuous wave output of said amateur radio transmitter.
